(19) United States
(12) Patent Application Publication
(10) Pub. No.: US 2020/0186867 A1
(43) Pub. Date: Jun. 11, 2020

(54) GENERATION AND TRANSMISSION OF HIGH DEFINITION VIDEO

(71) Applicants: Leonard PIMENTEL, New York, NY (US); LOTUS RESEARCH, INC., New York, NY (US)

(72) Inventor: Leonard Pimentel, New York, NY (US)

(21) Appl. No.: 16/316,471

(22) PCT Filed: Jul. 7, 2017
(86) PCT No.: PCT/US2017/041240

§ 371 Date: Jan. 9, 2019

Related U.S. Application Data
(60) Provisional application No. 62/360,332, filed on Jul. 9, 2016.

(51) Int. Cl. H04N 21/431; H04N 21/2187; H04N 21/2343; H04N 21/472; H04N 21/482; H04N 21/41

(52) U.S. Cl. CPC H04N 21/4314; H04N 21/2187; H04N 21/234363; H04N 21/4126; H04N 21/47202; H04N 21/4821; H04N 21/23439

(57) ABSTRACT

Systems, devices, computer readable storage mediums, and methods are disclosed for generating and distributing high definition videos and photos. In one aspect, a method includes presenting, by a client device, a scrollable first plurality of thumbnails, each of the first plurality of thumbnails representing different content from a first source of information; and presenting, by the client device, a scrollable second plurality of thumbnails, positioned laterally adjacent to the first plurality of thumbnails, each of the second plurality of thumbnails representing different content from a second source of information.

### CROSS REFERENCE TO RELATED APPLICATIONS

This application claims priority to U.S. Provisional Patent Application No. 62/360,332, filed Jul. 9, 2016 and entitled “GENERATION AND TRANSMISSION OF HIGH DEFINITION VIDEO.” The content of this prior application is considered part of this application, and is hereby incorporated by reference in its entirety.

### TECHNICAL FIELD

Embodiments described herein relate to high definition video, and to systems, methods, devices, that generate and/or transmit high definition video.

### SUMMARY

Disclosed are methods, devices, and computer readable mediums to facilitate transmission of high definition video. In some aspects, transmissions are tailored specifically for the use at a destination. For example, if a photo is to be utilized as a thumbnail, a lower resolution photo may provide adequate quality. Thus, a smaller version of the photo may be transmitted over the network, consuming less bandwidth and making the photo available earlier than if a full resolution version of the photo was transmitted.

In some other aspects, a user may provide a live video feed for distribution to one or more other devices. In some aspects, the video feed may be provided to a centralized backend, which then streams the video to the one or more devices as needed. While many video systems utilize a frame of the video as a preview image, which may be utilized to facilitate selection of the video by video players, the disclosed methods and systems may instead capture a separate photo via an imaging sensor, and then reconfigure the imaging sensor to capture video. The photo may be provided as a preview image to the backend. To further facilitate rapid distribution of the preview image, the resolution of the preview image may be reduced relative to that captured by the imaging sensor. As network bandwidth permits, or in some cases, after the video has been streamed completely to the back-end, a higher resolution version of the preview image may be transmitted to the backend to replace the initial, lower resolution version. In some aspects, this may all occur automatically, without additional user input. In other words, a user may select a user interface control to begin streaming video, and in response to the single user input, the disclosed devices and methods may capture the photo, reduce the resolution of the photo, transmit the reduced resolution photo to the backend, reconfigure the imaging sensor for video mode, capture video from the image sensor and stream the video to the backend. Further, the low resolution image may then be replaced by a higher resolution version, again all without further input from the user interface.

Another aspect disclosed is a method and device for providing an instant messaging conversation that may include multiple live video feeds from different participants to the instant messaging conversation. In some aspects, each of the live video feeds may have an access control list. The access control list specifies which participants or social network members are provided with access to the live video. In some aspects, the access list may specific a subset of participants to the instant messaging conversation itself.

Another aspect disclosed is a method of providing preview images for videos. The method includes receiving, by a first electronic device, a first image having a first resolution from a second electronic device, receiving, by the first electronic device, from the second electronic device, a message identifying a video stream, and identifying an association between the first image and the video stream, mapping, by the first electronic device, the first image to the video stream, transmitting, by the first electronic device, a second message to a third electronic device, the message including the first image, receiving, by the first electronic device, a third message from the third electronic device, the third message indicating selection of the first image, transmitting, by the first electronic device, the video stream to the third electronic device in response to the selection of the first image, receiving, by the first electronic device, a second image having a second resolution from the second electronic device, the message further identifying an association between the second image and the video stream, mapping, by the first electronic device, the second image to the video stream, transmitting, by the first electronic device, a fourth message to the third electronic device, the message including the second image, and an indication that the second image replaces the first image, receiving, by the first electronic device, a fifth message from the third electronic device indicating selection of the second image, and transmitting, by the first electronic device, the video stream to the third electronic device in response to the selection of the second image and the mapping of the second image to the video stream.

In some aspects, the method also includes determining a quality of a network connection between the first electronic device and the third electronic device, determining a resolution for the video stream based on the quality, transmitting the video stream at the determined resolution to the third electronic device. In some aspects, the method also includes storing segments of the video stream at a first resolution, storing second segments of the video stream at a second resolution, wherein the second segments and first segments overlap; and selecting either first segments or second segments based on the determined quality, wherein the transmitting of the video stream transmits the selected segments.

Some aspects of the method also include receiving, by the first electronic device, a message from the second electronic device revoking permission for the video stream; and transmitting, by the first electronic device, a message indicating the revocation. In some aspects, the video stream is a live video stream.

Another method disclosed displays information. The method includes presenting, by a client device, a scrollable first plurality of thumbnails on a display screen of the client device, each of the first plurality of thumbnails representing different content from a first source of information, presenting, by the client device, a scrollable second plurality of thumbnails on the display screen, the second plurality of thumbnails positioned laterally adjacent to the first plurality of thumbnails, each of the second plurality of thumbnails representing different content from a second source of information, receiving, by the client device, content from the second source of information, and updating, by the client device, the presentation of the first plurality of thumbnails and the second plurality of thumbnails by changing an ordinal position of the first plurality of thumbnails relative to the second plurality of thumbnails in response to the received content.

In some aspects, the method also includes receiving, by the client device, input indicating a selection of one of the first scrollable plurality of thumbnails, requesting, in response to the input, content corresponding to the one scrollable thumbnail from the first source of information based on the representation of the first source of information by the first plurality of scrollable thumbnails. In some aspects, the method also includes receiving, by the client device, a message from a network indicating at least one of the first plurality of thumbnails, and an association between the one thumbnail and the first source of information; and presenting the one thumbnail in response to receiving the message. In some aspects, the method includes receiving, by the client device, input indicating a scroll operation for the first plurality of scrollable thumbnails, scrolling the first plurality of thumbnails in response to the input while maintaining a position of the second plurality of thumbnails.

In some aspects, the input indicates a scroll operation is a horizontal swipe, and the scrolling of the first plurality of thumbnails is a horizontal scroll. In some aspects, the first plurality of thumbnails are presented in a horizontal row, and the second plurality of thumbnails are presented in a second horizontal row. In some aspects, the input indicating a scroll operation is a vertical swipe, and the scrolling of the first plurality of thumbnails is a vertical scroll. In some aspects, the first plurality of thumbnails are presented in a vertical column, the second plurality of thumbnails are presented in a second vertical column, and the first and second vertical columns are laterally adjacent.

Another aspect disclosed is a wireless handset. The wireless handset includes an electronic hardware processor, electronic memory storing instructions that when executed, configure the electronic hardware processor to: present a scrollable first plurality of thumbnails, each of the first plurality of thumbnails representing different content from a first source of information, present a scrollable second plurality of thumbnails, positioned laterally adjacent to the first plurality of thumbnails, each of the second plurality of thumbnails representing different content from a second source of information, receive content from the second source of information; and update the presentation of the first plurality of thumbnails and the second plurality of thumbnails by changing an ordinal position of the first plurality of thumbnails relative to the second plurality of thumbnails in response to the received content.

In some aspects, the electronic memory stores further instructions that when executed, configure the electronic hardware processor to receive input indicating a selection of one of the first scrollable plurality of thumbnails, request content corresponding to the one scrollable thumbnail from the first source of information based on the representation of the first source of information by the first plurality of scrollable thumbnails. In some aspects, the electronic memory stores further instructions that when executed, configure the electronic hardware processor to receive a message from a network indicating at least one of the first plurality of thumbnails, and an association between the one thumbnail and the first source of information; and present the one thumbnail in response to receiving the message.

In some aspects, the electronic memory stores further instructions that when executed, configure the electronic hardware processor to receiving, by the client device, input indicating a scroll operation for the first plurality of scrollable thumbnails, scrolling the first plurality of thumbnails in response to the input while maintaining a position of the second plurality of thumbnails. In some aspects, the input indicates a scroll operation is a horizontal swipe, and the scrolling of the first plurality of thumbnails is a horizontal scroll.

In some aspects, the input indicates a scroll operation is a vertical swipe, and the scrolling of the first plurality of thumbnails is a vertical scroll. In some aspects, the first plurality of thumbnails are presented in a vertical column, the second plurality of thumbnails are presented in a second vertical column, and the first and second vertical columns are laterally adjacent.

Another aspect disclosed is a non-transitory computer readable medium comprising instructions that when executed cause a processor to perform a method of displaying content, comprising presenting, by a client device, a scrollable first plurality of thumbnails on a display screen of the client device, each of the first plurality of thumbnails representing different content from a first source of information, presenting, by the client device, a scrollable second plurality of thumbnails on the display screen, the second plurality of thumbnails positioned laterally adjacent to the first plurality of thumbnails, each of the second plurality of thumbnails representing different content from a second source of information, receiving, by the client device, content from the second source of information; and updating, by the client device, the presentation of the first plurality of thumbnails and the second plurality of thumbnails by changing an ordinal position of the first plurality of thumbnails relative to the second plurality of thumbnails in response to the received content.

### BRIEF DESCRIPTION OF THE DRAWINGS

The drawings illustrate example embodiments of the present disclosure and do not limit the scope of the present disclosure.

FIG. 1 is a simplified block diagram illustrating one possible system of generating and transmitting high definition video and photos.

FIG. 2 is a simplified block diagram illustrating one possible handset that generates high definition video and photos.

FIG. 3 is a simplified block diagram illustrating one possible backend that distributes high definition video and photos.

FIG. 4 is a simplified example flowchart of a handset that dynamically adjusts the settings for the generation of video by the handset.

FIG. 5 is a simplified example flowchart of a handset that determines whether to stream live video or store the video locally.

FIG. 6 shows an alternative to FIG. 5, and is a simplified example flowchart of a handset that streams live video and stores the video locally.

FIG. 7 is a simplified bounce diagram showing that the handset takes a photo prior to the making a video, such that the photo is used in a notification of the video to a viewing device.

FIG. 8 is a simplified bounce diagram showing that the handset sends a photo of worse quality prior to the sending a video, such that the worse quality photo is used in a notification of the video to a viewing device.

FIG. 9 is a simplified bounce diagram showing that the handset sends an updated photo or video frame that is used in a notification of a video to a viewing device.

FIG. 10 is a simplified bounce diagram showing how the viewing device receives, based on the quality of the connection, automatically different versions of a photo or video frame that is divided into different parts.

FIG. 11A is a simplified bounce diagram showing that permission of the viewing device to watch live video or previously streamed video is dynamically revoked.

FIG. 11B is an exemplary database that may provide individual access control lists for videos.

FIG. 12A is a simplified diagram of a carousel representation of content items from a content source.

FIG. 12B is a simplified diagram of a carousel representation of content items from a content source.

FIG. 13 is a simplified diagram of an aggregated view about viewing devices that view content.

FIG. 14 is a block diagram illustrating an example of a software architecture for generating and transmitting high definition video and photos according to some example embodiments.

FIG. 15 is a diagrammatic representation of a machine in the form of a computer system within which a set of instructions are executable, causing the machine to perform generating and transmitting high definition video and photos according to some example embodiments.

FIG. 16 is a mock-up of an exemplary instant messaging conversation window 1600 that may be presented on a screen of the handset 102.

FIG. 17 is an exemplary database to facilitate the conversation 1602 shown above with respect to FIG. 16.

FIG. 18 is a flowchart for a method of providing access to messages in an instant message conversation.

### DETAILED DESCRIPTION

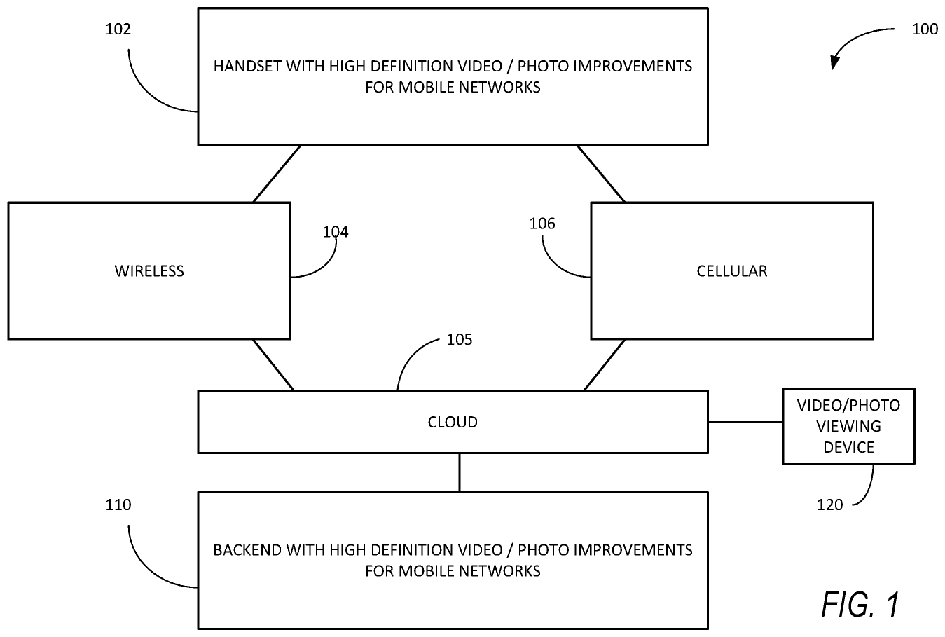

FIG. 1 is a simplified block diagram illustrating one possible system 100 of generating and transmitting high definition video and photos.

A handset 102 has high definition video/photo improvements for mobile networks. Such improvements assist the handset 102 with generating and distributing photo and video content for mobile networks. The handset 102 sends high definition video/photo to the backend 108 with high definition video/photo improvements for mobile networks. The handset 102 communicates with the backend 110 via a wireless network 104 and a cloud 105, or via a cellular network 106 and the cloud 105. Alternatively, the handset 102 can switch one or more times between the wireless 104 and cellular 106 networks during a session. The handset 102 makes video/photo content and sends the video/photo content to the backend 110. The backend 110 may store and distribute the video/photo content that was generated by the handset 102. A video/photo viewing device 120 views the content generated by the handset 102 and distributed by the backend 110.

In other embodiments, the handset 102 is instead any of a desktop computer, a tablet, a wearable computer, and a professional video camera.

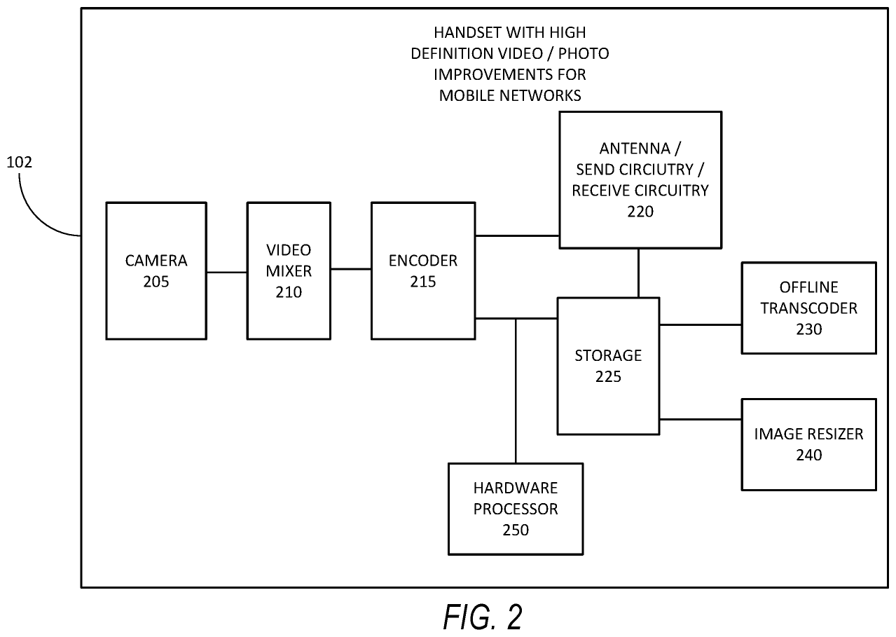

FIG. 2 is a simplified block diagram illustrating one possible handset 102 that generates high definition video and photos.

A camera 205 receives images through an optical element such as a lens and converts the images into electrical signals with an image sensor such as a CCD sensor chip or CMOS sensor chip. A video mixer 210 performs one or more image mixing functions such as transposition, color mapping, and real time filtering. An encoder 215 encodes the video stream in a compressed format such as H.264, MPEG-4, MPEG-2, H.263, MPEG-4 Part 2, SMPTE 421M, and Dirac. The compressed video stream is sent to a send/receive circuitry block 220 with an antenna. In another embodiment, the compressed video stream or photo is sent to local storage 225. Local storage 225 may be an electronic memory, such as random access memory, or may be stable storage, such as a hard disk. Once the compressed video stream or photo is in local storage 220, then an offline transcoder 230 is able to transcode the video into a different compressed format, or an image resizer 240 is able to resize the image to a smaller size than the original size. A hardware processor 250 may control the hand-set 102. For example, the hardware processor 250 may be operably connected to one or more of the other components of the handset 102. The hardware processor 250 may be configured by instructions stored in the storage 225 to perform one or more functions described herein. In some aspects, the handset 102 may include a display, such as a touchscreen display in some aspects (not shown in FIG. 2). The display may be operably connected to the processor 250, such that the processor 250 may control what data is displayed on the display.

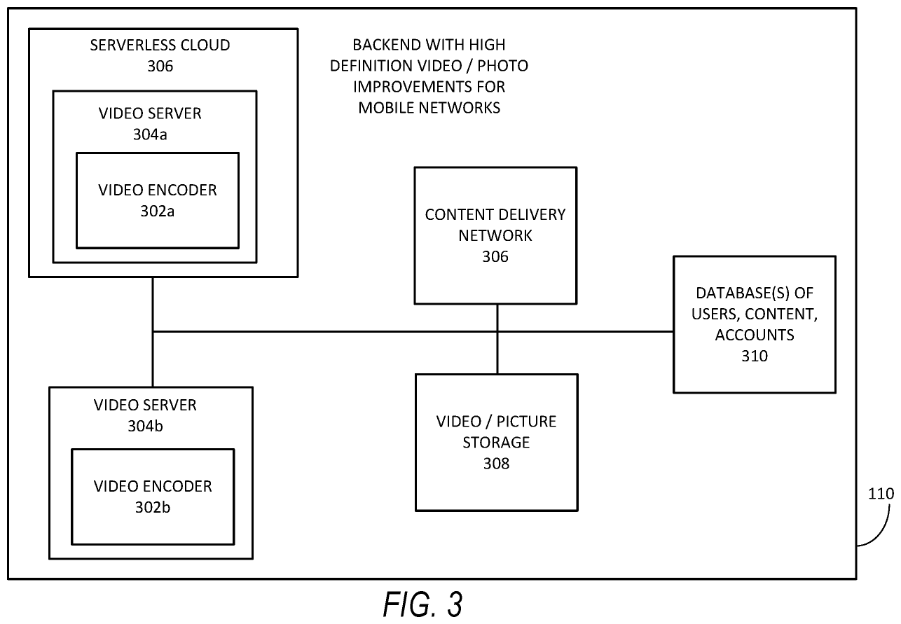

FIG. 3 is a simplified block diagram illustrating one possible backend 110 that distributes high definition video and photos. Databases 310 store records of users, records of content such as videos and photos, and records of accounts that are held by users. The actual videos and photos are held in video/picture storage 308. Video/picture storage 308 store multiple versions of a video/photo of varying quality. A video server 304b with a video encoder 302b receives the original video or photo of the best quality, and then encodes multiple versions of a video/photo of varying quality. Alternatively, a video server 304a with the video encoder 302a is supported by a serverless cloud service 306 such as AWS Lambda. Similar cloud embodiments exist for other parts of the backend 110. For example, in another embodiment the database 310 is supported by a cloud service such as Amazon Relational Database Service. In another embodiment the storage 308 is supported by a cloud service such as Amazon S3. Other embodiments combine a mixture of cloud services with computers and devices provisioned by the user of the computers and devices.

Networking hardware such as routers, switches, and hubs (not shown) interconnect the elements of the backend. Inputs and outputs of the elements of the backend 110 transit such networking hardware as the inputs and outputs are communicated between different elements of the backend 110.

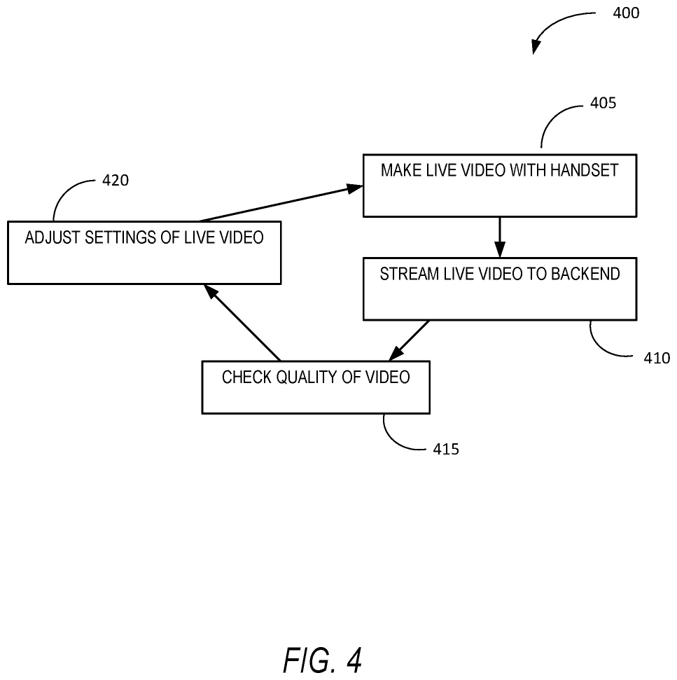

FIG. 4 is a flowchart of an exemplary method of dynamic adjustment of settings for the generation of video by a handset. The method 400 discussed below with respect to FIG. 4 may be performed by an electronic hardware processor, for example, the hardware processor 250 discussed above with respect to FIG. 2.

In block 405, the handset makes live video. In block 410, the handset streams live video to the backend. The quality of the video is checked in block 415, either by the handset or by the backend which then notifies the handset. The handset adjusts the settings of the video in block 420 based on the quality of the video. Process 400 may then return to block 405.

In one example of process 400 operation, a handheld has different camera settings for photos and videos. Because a video is essentially a rapid sequence of still video frames which leave little time between successive frames, the default shutter speed for video is generally faster than the default shutter speed for photos. In one embodiment, at low-light conditions such as night-time, or a dark room, or overcast weather, the default shutter speed for videos is overridden, to be more comparable to the shutter speed for photos.

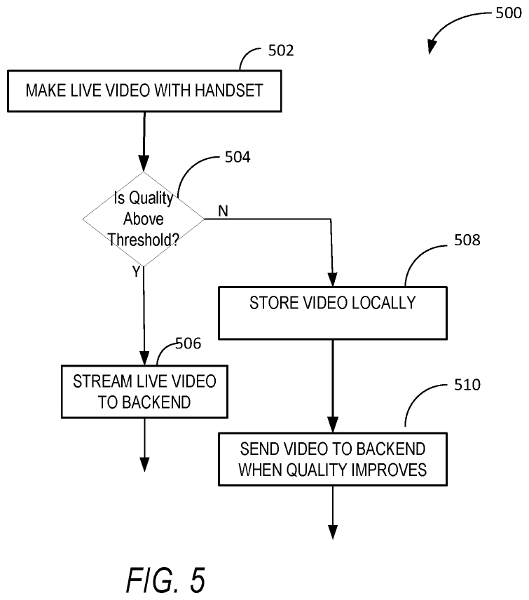

FIG. 5 is a flowchart of an exemplary method of determining whether to stream live video or store the video locally by a handset. The method 500 discussed below with respect to FIG. 5 may be performed by an electronic hardware processor, for example, the hardware processor 250 discussed above with respect to FIG. 2.

In block 502, the handset makes live video. The quality of the mobile connection is checked in decision block 504, either by the handset or by the backend which then notifies the handset. If the quality is above a threshold, then the live video is streamed to the backend in block 506. If the quality is unacceptable (e.g. below or equal to the threshold), then the video is stored locally in block 508, and subsequently the stored video is sent to the backend in block 510, perhaps when the quality of network connectivity between the handset and the backend improves.

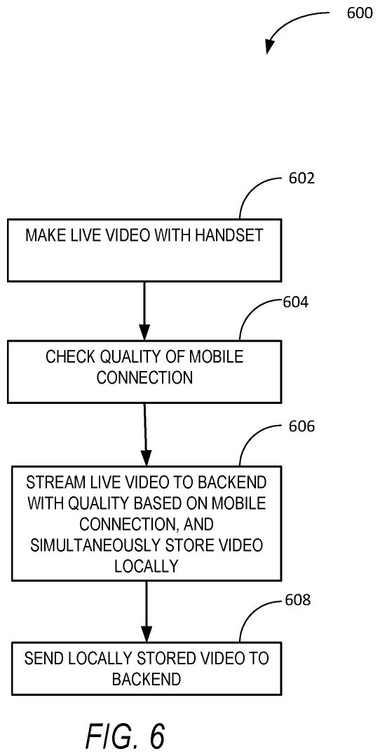

FIG. 6 shows an alternative to FIG. 5, and is a flowchart of an exemplary method of streaming live video and storing the video locally. In some aspects, the process 600 may be performed by the handset 102. The method 600 discussed below with respect to FIG. 6 may be performed by an electronic hardware processor, for example, the hardware processor 250 discussed above with respect to FIG. 2.

The handset 102 makes live video in block 602. The quality of the mobile connection is checked in block 604, either by the handset 102 or by the backend 110 which then notifies the handset 102. If the quality is acceptable, then the live video is streamed to the backend in block 606. If the quality is unacceptable, then the live video is not streamed to the backend 110. However, regardless of whether the live video is streamed or not streamed, video is stored locally in block 606, and subsequently the stored video is sent to the backend 110 in block 608. This embodiment is advantageous in that, even if the live video is streamed, the quality of the live video may be degraded intentionally due to slow mobile bandwidth, or unintentionally due to unexpected errors. In these aspects, the stored video may have better quality than the streamed video, and the stored video is later sent to the backend 110. In some aspects, block 608 is performed in response to a user input. For example, the user input may indicate that the locally stored video is to be transmitted to the backend 110.

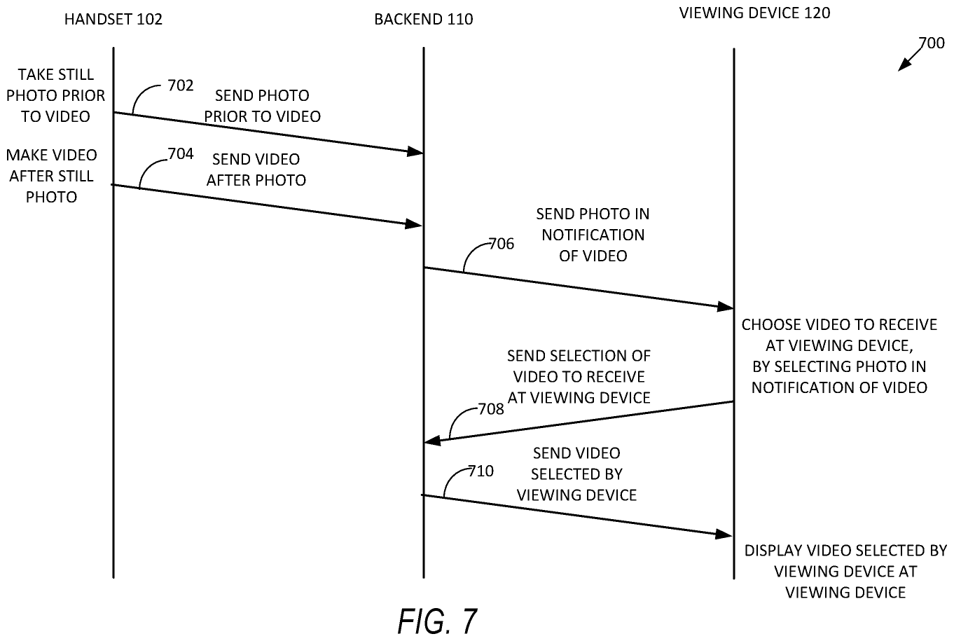

FIG. 7 is a simplified bounce diagram showing that the handset takes a photo prior to the making a video, such that the photo is used in a notification of the video to a viewing device. FIG. 7 also demonstrates a method that may be performed by a hardware processor in the handset 102.

The message exchange and method demonstrated by the bounce diagram of FIG. 7 may be initiated by a single user interface input in some aspects. For example, a user of the handset 102 may signal, via a user interface control such as a button, that live video is to be streamed from the handset 102.

In response to the signal to stream live video, the handset 102 takes a still photo prior to making a video. The photo is sent from the handset 102 to the backend 110 via message 702. In some aspects, the photo may be captured based on an intended use of the photo at the back-end 110. For example, in aspects that may utilize the photo as a thumbnail, image sensor resolutions may be configured to be lower than a resolution that might be used in a larger image.

Without any further user input, the handset 102 may then make/stream a video after taking the still photo. The video may then be sent from the handset 102 to the backend 110 via message 704.

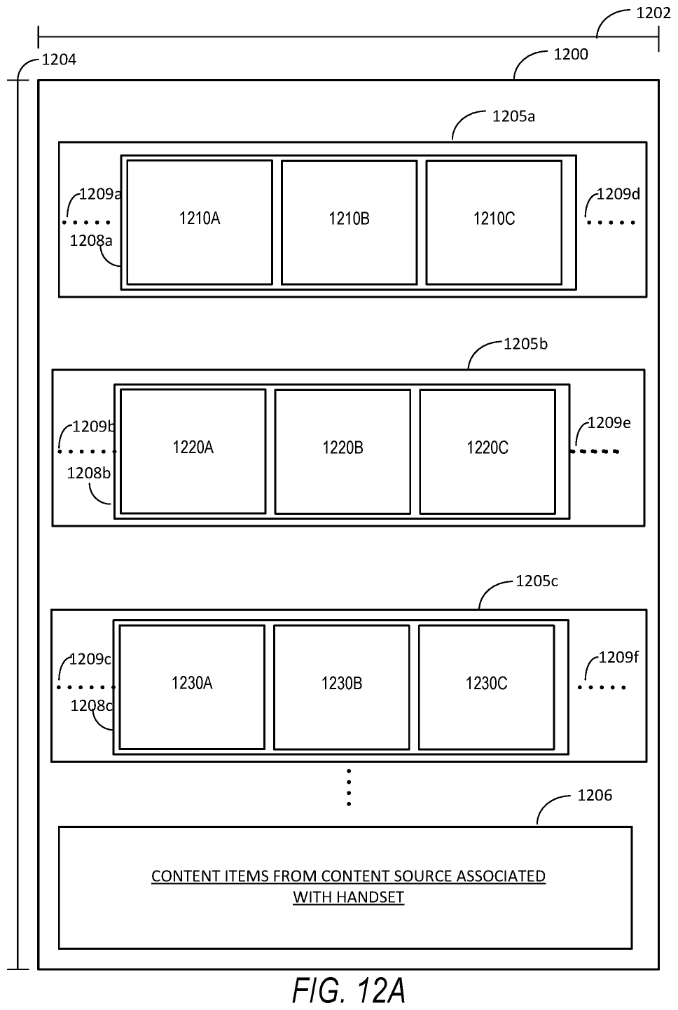

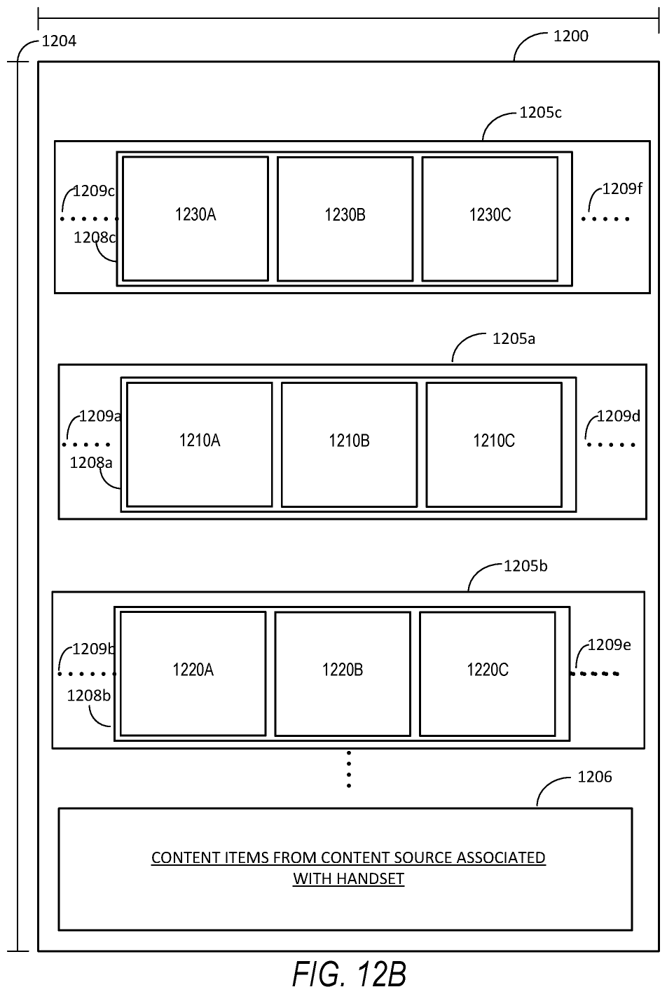

Upon receiving the photo from the handset 102, the backend 110 sends the photo in a notification message 706 of the video to the viewing device 120. The viewing device may be viewing a page that includes an area where live feeds from the handset 102 would be provided. The notification message 706 may be sent, in some aspects, in response to the viewing device 120 requesting the page. At the viewing device 120, the video can be chosen by selecting the photo in the notification message 706 of the video. For example, a user of the video device 120 may provide input selected the photo. The photo may be presented as a thumbnail at the viewing device 120, for example, as a thumbnail in a carousel, discussed in connection with FIG. 12 below. The viewing device 120 sends an indication of the selection of the video to the backend 110 via a message 708. The backend 110 sends/streams the selected video to the viewing device 120 via one or more message(s) 710. In some aspects, the backend 110 may generate multiple versions of the video. For example, the multiple versions may vary based on one or more of a resolution, a dots per inch, a frame rate, and a video size. In some aspects, the backend sends one of the versions of the video to the viewing device 120 based on one or more of a screen size of the viewing device 120, whether the video is maximized or not at the viewing device (or another indication of the size of the display area for the video at the viewing device), and a bandwidth available between the backend and the viewing device 120. The viewing device 120 displays the video, or alternatively stores the video for later display.

This embodiment allows more careful choice of a photo that is more representative or laudatory of the video in the notification of the video. By contrast, a notification of the video which simply uses a predetermined frame such as the first frame of the video may be less laudatory and attract fewer selections of the video. Furthermore, ease of use with regard to streaming of live video is enhanced, while performance and responsiveness of the system are also improved. For example, the user of the handset 102 need only provide one user interface input to stream their live video to the back-end. This operation may include both capturing a photo, sending the photo to the backend, then streaming a live video stream to the back-end as shown above.

Furthermore, the handset 102 may include an image sensor that includes a photo mode and a separate video mode. The image sensor may need to be configured to capture photos and then separately configured to capture videos. The bounce diagram 700 demonstrates that a user may capture the photo, reconfigure the image sensor, and stream live video via one user interface input. For example, the image sensor may be configured to be in a photo mode when bounce diagram 700 begins. Between message 702 and message 704, the image sensor may be reconfigured to video mode. In some aspects, all of the messages transmitted by the handset 102 shown in FIG. 7, and the image sensor configuration and reconfiguration described above, may be accomplished via one user interface input.

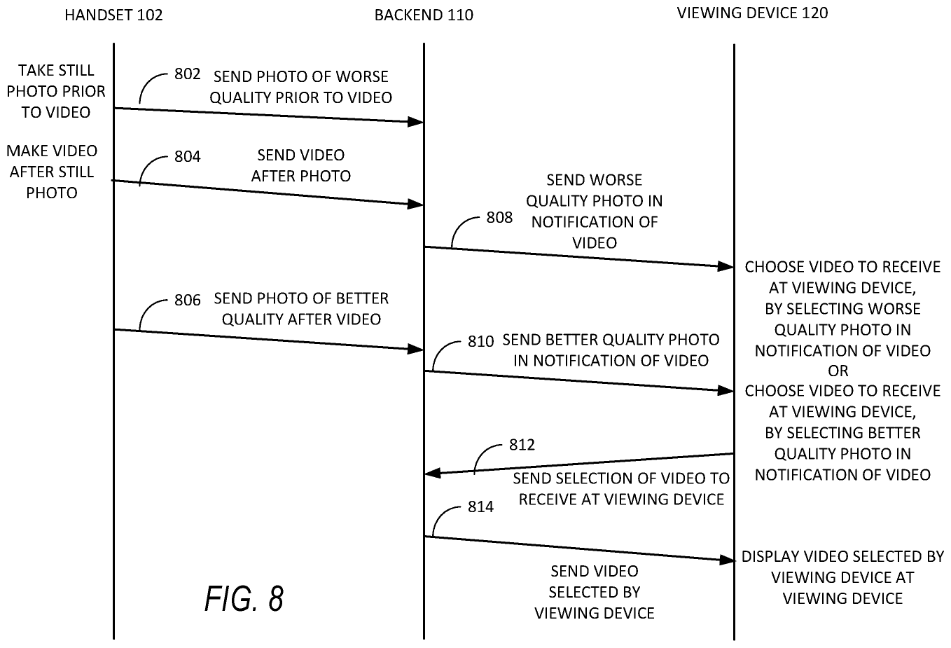

FIG. 8 is a simplified bounce diagram showing that the handset 102 sends a photo of worse quality via message 802 prior to the sending a video via message 804, such that the worse quality photo is used in a notification of the video to a viewing device 120. FIG. 8 also demonstrates a method that may be performed by a hardware processor in the handset 102.

The message exchange and method demonstrated by the bounce diagram of FIG. 8 may be initiated by a single user interface input in some aspects. For example, a user of the handset 102 may signal, via a user interface control such as a button, that live video is to be streamed from the handset 102.

The handset 102 takes a still photo prior to making a video (e.g. the photo may be captured at a first resolution). After downscaling the still photo to a photo of worse quality (e.g. a second resolution lower than the first resolution), the photo is sent from the handset 102 to the backend 110 via the message 802. The handset makes a video after taking the still photo. Then the video is sent from the handset 102 to the backend 110 via the message 804. As discussed above with respect to FIG. 7, the handset 102 may utilize an imaging sensor that maintains a photo capture mode and a separate video capture mode, each of which must be individually configured. The configuration of the imaging sensor for photo (to capture the photo and send the message 802) and configuration of the imaging sensor for video (to capture the video and send the one or more messages 804) may all be performed in some aspects in response to a single user interface input.

The backend 110 sends the worse quality photo in a notification message 808 of the video to the viewing device 120. At the viewing device 120, the video can be chosen by selecting the worse quality photo in the notification message 808 of the video. An example result of the viewing device 120 receiving the notification message is a thumbnail in a carousel, discussed in connection with FIG. 12. The handset 102 sends the selection of the video to the backend 110 via the message 812. The backend 110 sends the selected video to the viewing device 120 via the message 814. The viewing device 120 may then display the video, or alternatively store the video for later display.

In a variation, after the video is sent from the handset 102 to the backend 110, in some aspects, without any further input from a user via a user interface of the handset 102, the handset 102 sends the original still photo of better quality (e.g. first resolution) to the backend 110 via message 806. The backend 110 sends the better quality photo to the viewing device 120 via message 810. At the viewing device 120, the video can be chosen by selecting the better quality photo in a thumbnail for the video displayed on the device 120. An example notification is a thumbnail in a carousel, discussed in connection with FIG. 12. The handset 102 sends the selection of the video to the backend 110. The backend 110 sends the selected video to the viewing device 120 via message 814. The viewing device 120 displays the video, or alternatively stores the video for later display.

This embodiment allows the video to be chosen at the viewing device 120 by selecting a worse quality photo. Such a selection relies on the worse quality photo rather than the better quality photo, and the duration of transmitting the worse quality photo is shorter than the duration of transmitting the better quality photo. Thus, even for slow mobile connections, the viewing device 120 receives the notification of the video more quickly. In turn, the video can be chosen at the viewing device 120 more quickly.

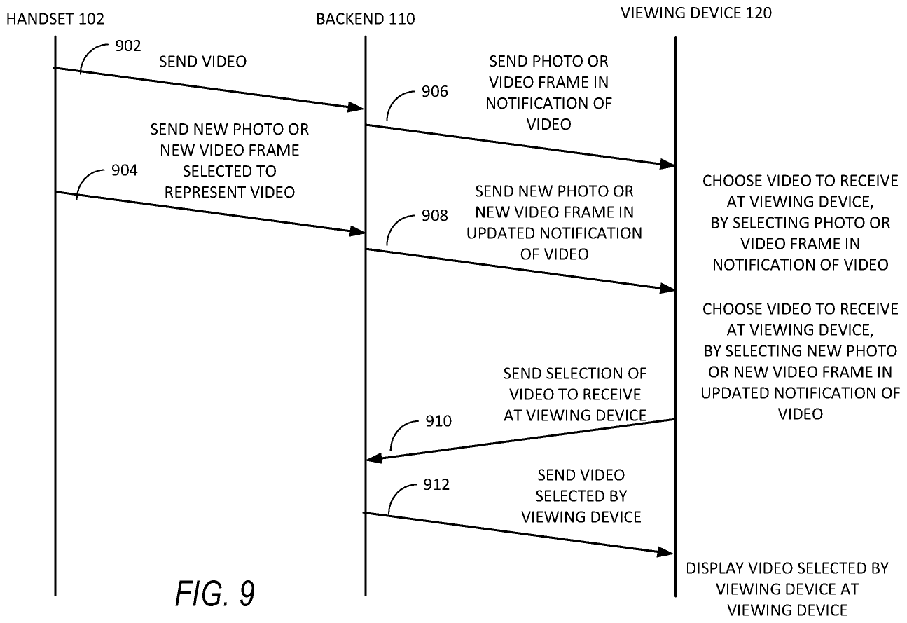

FIG. 9 is a simplified bounce diagram showing that the handset sends an updated photo or video frame that is used in a notification of a video to a viewing device. FIG. 9 also demonstrates a method that may be performed by a hardware processor in the handset 102.

The message exchange and method demonstrated by the bounce diagram of FIG. 9 may be initiated by a single user interface input in some aspects. For example, a user of the handset 102 may signal, via a user interface control such as a button, that live video is to be streamed from the handset 102.

The handset 102 sends a video to the backend 110 via a message 902 in response to the user interface input in some aspects. The backend 110 sends a photo or video frame in a notification message 906 of the video to the viewing device 120. At this point, the video can be chosen at the viewing device 120 by selecting the photo or video frame indicated in the notification message 906. An example result of the viewing device 120 receiving the notification message 120 is for the viewing device 120 to display a thumbnail in a carousel, discussed in connection with FIG. 12.

The handset 102 sends a new photo or new video frame selected to represent the video, to the backend 110 via a network message 904. The backend 110 sends the new photo or new video frame in an updated notification message 908 of the video to the viewing device 120. At this point, the video can be chosen at the viewing device 120 by selecting the new photo or the new video frame in the updated notification of the video. Upon receiving the updated notification message 908, the viewing device 120 may update the thumbnail generated when the notification message 906 was received.

In either or both cases, the selection of the video is sent from the viewing device 120 to the backend 110 via a selection message 910. The backend 110 sends the video to the viewing device 120 via one or more messages 912. The viewing device 120 displays the video or stores the video for later viewing.

This embodiment allows the creator of the video to efficiently change the photo or video frame that represents the video, without having to endure the whole process of submitting a video to the backend 110. This may be accomplished in some aspects, via a user interface presented on the handset 102. The user interface may enable the user to select a new photo to represent the video, or to select a particular frame in the video to represent the video. The selected photo or frame of video may then be sent to the backend via the message 904.

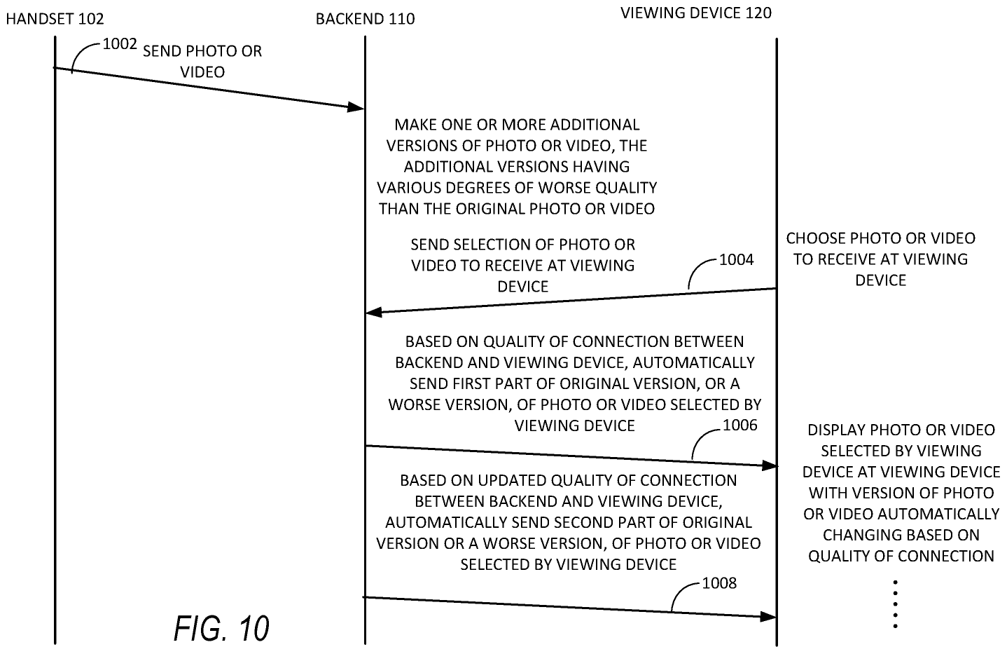

FIG. 10 is a simplified bounce diagram showing how the viewing device 120 receives, based on the quality of the connection, automatically different versions of a photo or video frame that is divided into different parts.

A photo or video is sent from the handset 102 to the backend 110 via a network message 1002. At the backend 110, one or more additional versions of the photo or video are made. The additional versions have various degrees of worse quality (e.g. resolution) than the original photo or video.

At the viewing device 120, a photo or video is chosen to receive at the viewing device 120. The selection of the photo or video is sent from the viewing device 120 to the backend 110 via selection message 1004.

Based on the quality of the connection between the backend 110 and the viewing device 120, the backend 110 automatically sends a first part of the original version (originating from the handset 102), or a first part of a worse version, to the viewing device 120 via a first set of one or more messages 1006. The viewing device 120 displays this first part.

Based on an updated quality of the connection between the backend 110 and the viewing device 120, the backend 110 automatically sends a second part of the original version (originating from the handset 102), or a second part of a worse version, to the viewing device 120 via a second set of one or more messages 1006. The viewing device 120 displays this second part. The first part and second part may be of different resolutions in some aspects. For example, if the quality of the network connection is different between transmission of the first and second parts, the backend 110 may select a next portion of the video having a different quality level. A first resolution portion of the video may be transmitted when the quality is above a threshold, and a second lower resolution portion of the video may be transmitted when the quality is blow the threshold.

When the content is a video, then the first part is an earlier video segment and the second part is a later video segment. After the additional versions are made, the additional versions are divided into segments or parts sharing the same time bases across the different versions. For example, if version 1 is divided into 1 second intervals, than version 2 is divided into minute intervals. Because the time bases are shared between the versions, switching between the versions can be accomplished at each point of time between intervals. For example, better quality version 1 plays from 0 second to 1 second. At this point, the connection quality worsens. Then the worse quality version plays from 1 second to 4 seconds. At this point, the connection quality improves. Then the better quality version plays from 4 seconds onward.

When the content is photos, then the first part is an earlier photo in a series of photos and the second part if a later photo in the series of photos. Different versions of the series of photos are shown depending upon the connection quality.

This embodiment allows a continuous viewing experience at the viewing device 120 even with varying connection quality. In some aspects, the viewing device 120 may communicate to the backend 110 a quality criteria for the video. For example, in some aspects, the viewing device 120 may communicate a minimum resolution required for video. In some aspects, the viewing device 120 may select the minimum resolution based on one or more of a screen size, display resolution, and/or video window player size. In some aspects, the viewing device 120 may communicate a maximum video resolution. The maximum may also be based, in some aspects, on one or more of a screen size, display resolution. And or video player window size. By tuning the amount of data streamed between the back-end and the player device 120, a highest video playback experience may be obtained for a given network capacity, while utilizing the lowest amount of capacity to provide that video experience.

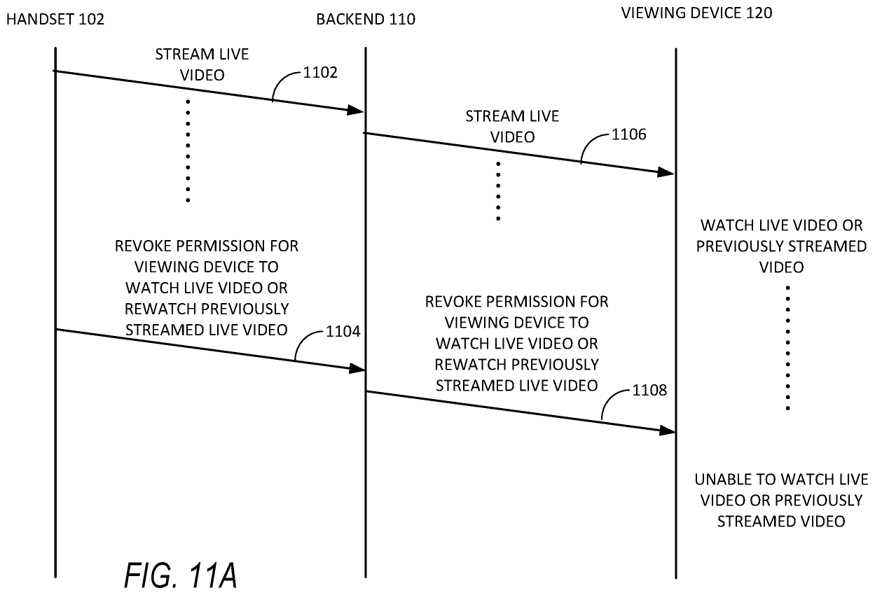

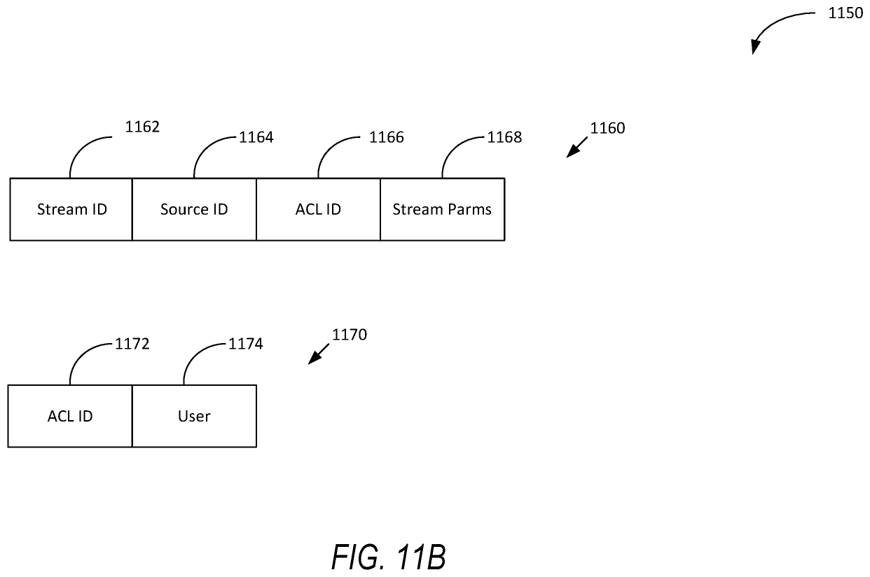

FIG. 11A is a simplified bounce diagram showing that permission of the viewing device 120 to watch live video or previously streamed video is dynamically revoked.

The handset 102 streams live video to the backend 110 via one or more network messages 1102. The backend 110 streams live video to the viewing device 120 via one or more network messages 1106. At this time, the viewing device 120 watches live video or previously streamed video.

Then, the handset revokes permission for the viewing device 120 to watch live video or to rewatch previously streamed live video. The revocation is communicated to the back-end via message 1104. The backend 110 sends to the viewing device 120 the revocation of the permission for the viewing device 120 to watch live video or to rewatch previously streamed live video via network message 1108. At this time, the viewing device 120 is unable to watch live video or previously streamed video.

In some aspects, the functionality described above with respect to FIG. 11A may be provided via an access control list for the live stream video discussed above. One embodiment of an ACL is shown below with respect to FIG. 11B.

FIG. 11B shows an exemplary database 1150 that may provide for the revocation of access to a live stream video. Database 1150 includes a stream table 1160. The stream table maintains a record of live streams via a stream id 762, an originator id 764, an ad id 766, and stream parameters 768.

Database 1150 also includes an access control list table 1170. The access control list table stores ACLs via multiple rows having the same ACL ID. The users having access via the access control list are indicated via the user field 1174. In some aspects, the database 1150 of FIG. 11B may provide for the ability of users to dynamically modify a list of users with access to a live video stream. For example, a handset 102 providing a live video, as shown above in FIG. 11A, may specify an access control list for the live video when it is initiated, or at another time. The backend 110 may set the ACL ID 1166 for the stream based on the indication from the handset 102. The handset 102 may also modify the ACL at any time by updating the access control list table 1170 entries for the access control list.

FIG. 12 is a simplified diagram of a carousel representation of content items from a content source presented on a screen 1200 of a handset 102. The screen 1200 of the handset 102 may have a horizontal dimension 1202 and vertical dimension 1204. For example, the horizontal dimension may be a screen width when the screen is in a typical orientation used for viewing the screen. The vertical dimension 1204 may be perpendicular to the horizontal dimension 1202. In some aspects, the horizontal dimension 1202 may be more narrow than the vertical dimension 1204. The handset 102 may have high definition video/audio improvements for mobile networks.

The screen 1200 of the handset 102 organizes content items from multiple content sources into multiple carousels 1205a-c stacked vertically. The multiple carousels 1205a-c may be presented, in some aspects, by a processor, such as processor 250 of FIG. 2, writing information to the screen 1200, which may be part of a display of the handset 102. Each of the vertically stacked, laterally adjacent carousels 1205a-c represent a particular content source. The carousels 1205a-c are considered laterally adjacent because they are adjacent with respect to their narrower (width) dimension. In the example of FIG. 12, the carousels 1205 are longer in the horizontal dimension than in the vertical dimension. Thus, the horizontal is a longitudinal dimension and the vertical is the lateral dimension. Since the carousels 1205a-c are positioned such that their narrower dimensions are adjacent, the carousels 1205a-c are considered laterally adjacent. In embodiments that display individual carousels vertically, the horizontal dimension may be the lateral dimension. In these embodiments, carousels may also be positioned so as to be laterally adjacent.

Each of the vertically stacked carousels 1205a-c has a horizontal series of thumbnails. The horizontal series of thumbnails in the vertically stacked carousels 1205a-c may include a visible portion of thumbnails within a window 1208a-c respectively, and a non-visible portion of thumbnails, represented by the continuation notations 1209a-f. For example, carousel 1205a includes visible thumbnails 1210a-c, carousel 1205b includes visible thumbnails 1220a-c, and carousel 1205c includes visible thumbnails 1230a-c.

The screen 1200 also includes a portion 1206 allocated for content items from a content source associated with the handset 102. For example, the portion 1206 may display local content with respect to the handset 102 in some aspects.

Each thumbnail within a particular carousel 1205a-c represents or is linked to different content from a content source particular to the carousel, and selection of a thumbnail opens or requests the content represented by the thumbnail from that content source. Thus, in some aspects, selection of the thumbnail may request the content represented by the thumbnail from the content source. In some embodiments. the thumbnails are the worse quality photos or the still photos representing videos discussed elsewhere in this document. The horizontal series of thumbnails may include a visible portion (e.g. 1210a-c) and a non-visible portion. Providing a slide gesture input over the carousel (e.g. 1205a) to the left or right may slide thumbnails within the visible window 1208a to the left or right, respectively. As the horizontal series of thumbnails moves in the direction of the slide gesture, a new portion of the horizontal series of thumbnails may become visible in the window 1208a while another portion of the horizontal series of thumbnails may move from visible in the window 1208a to invisible. The order of thumbnails from left to right or right to left in various embodiments may be determined by one or more of the recency of content represented by the thumbnail, explicit user preference, alphabetical order, order of most use of the pieces of content with the particular handset or with the account, and so on. The vertical order of carousels 1205a-c from top to bottom or bottom to top in various embodiments is determined by one or more of a most recent piece of content received by the different carousels, explicit user preference, alphabetical order, order of most use of the carousels with the particular handset or with the account, and so on. Input indicating a slide up or slide down gesture may slide a visible portion of carousels up or down.

In some aspects, an ordinal position of the stacked carousels 1205a-c relative to each other may be modified upon reception of an input. In some aspects, the input indicates particular content for one of the carousels 1205a-c. For example, in some aspects, a carousel with a most recent content may be displayed at the top of the stacked carousels. If each carousel is arranged vertically, a carousel with a most recent content may be positioned as a leftmost carousel.

In some aspects, the carousel 1205c may receive new data for display. A carousel may receive new data for display if, for example, the content source associated with the carousel provides new media to a data feed displayed by the carousel. When the new data is received, the set of stacked carousels 1205a-c may be updated such that carousel 1205c may be placed at the top of the screen 1200, stacked above other carousels 1205a-b in the series of stacked carousels. This may result in the carrousel 1205b below the carousel 1205c, and carousel 1205b below carrousel 1205c. FIG. 12B shows an exemplary display screen including the carousels 1205a-c after carousel 1205c receives additional content. Carousel 1205c is displayed above the other carousels 1205a and 1205b.

In one embodiment, carousels 1205a-c operate independently from one another, such that sliding the visible window of thumbnails in one carousel does not slide the visible windows of thumbnails in other carousels. In another embodiment, carousels operate dependently on one another, such that sliding the visible window of thumbnails in one carousel does slide the visible windows of thumbnails in one or more other carousels.

In another embodiment, the carousels are stacked horizontally rather than vertically, and each of the horizontally stacked carousels has a vertical series of thumbnails each representing different content from the particular content source, and selection of a thumbnail opens the content represented by the thumbnail. In other respects the horizontally stacked carousels are similar to the vertically stacked carousels except that presentation and behavior is rotated 90 degrees with respect the presentation and behavior of the vertically stacked carousels. Similarly, the vertically stacked thumbnails are similar to the horizontally stacked thumbnails except that presentation and behavior is rotated 90 degrees with respect the presentation and behavior of the horizontally stacked thumbnails.

In another embodiment, the carousel stacks are oriented at an angle between 0 degrees (horizontally stacked) and 90 degrees (vertically stacked).

Positioned below the stacked carousels are the content items from the content source associated with the handset 102. Example content items are photos, videos, and text of the user's content, people the user follows, or people the user subscribes to, and machine selected content based on the user's preference and behavior. Another embodiment positions the content items from the content source associated with the handset 102 above the stacked carousels. In one embodiment, the carousel concept is applied to multiple views of the content items from the content source associated with the handset 102. In one embodiment, carousels operate independently from one another, such that sliding the visible window of in one carousel does not slide the visible windows of other carousels. In another embodiment, carousels operate dependently on one another, such that sliding the visible window of thumbnails in one carousel does slide the visible windows of thumbnails in one or more other carousels.

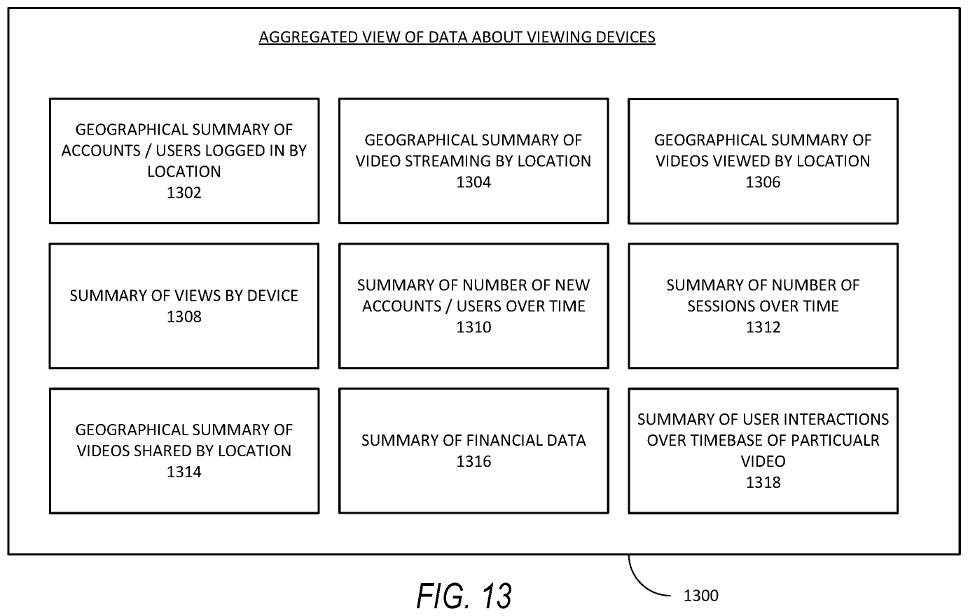

FIG. 13 is a simplified diagram of an aggregated view 1300 about viewing devices that view content.

The aggregated view includes: a geographical summary of accounts/users logged in by location 1302, a geographical summary of video streaming by location 1304, a geographical summary of video viewed by location 1306, a summary of views by device 1308, a summary of the number of new accounts/users over time 1310, a summary of numbers of sessions over time 1312, and a summary of financial data 1316. Other embodiments have in the aggregated view a geographical summary of a number of videos shared from a location 1314, or shared to a location. Other embodiments have in the aggregated view, for a particular video, throughout the timebase of the video, a number of end user interactions such as shares, chats, likes, and comments with various granularities of time 1318. Such an embodiment enhances visibility of the content creator into the specific part of the shared content which attracted or repelled interactions by the end user.

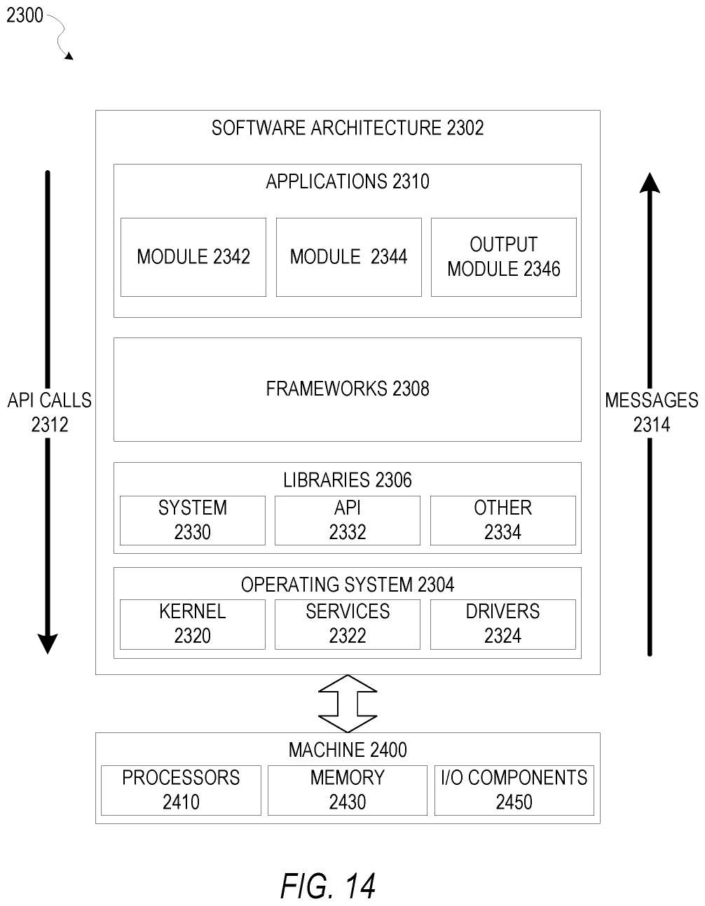

FIG. 14 is a block diagram 2300 illustrating an example of a software architecture 2302 to implement any of the methods described herein.

FIG. 14 is merely a non-limiting example of a software architecture 2302, and it will be appreciated that many other architectures can be implemented to facilitate the functionality described herein. In various embodiments, the software architecture 2302 is implemented by hardware such as machine 2400 of FIG. 14 that includes processors 2410, memory 2430, and I/O components 2450. In this example, the software architecture 2302 can be conceptualized as a stack of layers where each layer may provide a particular functionality. For example, the software architecture 2302 includes layers such as an operating system 2304, libraries 2306, frameworks 2308, and applications 2310. Operationally, the applications 2310 invoke application programming interface (API) calls 2312 through the software stack and receive messages 2314 in response to the API calls 2312, consistent with some embodiments. In various embodiments, any client device, server computer of a server system, or any other device described herein may operate using elements of software architecture 2302.

In various other embodiments, rather than being implemented as modules of one or more applications 2310, some or all of modules 2342, 2344, and 2346 may be implemented using elements of libraries 2306 or operating system 2304.

In various implementations, the operating system 2304 manages hardware resources and provides common services. The operating system 2304 includes, for example, a kernel 2320, services 2322, and drivers 2324. The kernel 2320 acts as an abstraction layer between the hardware and the other software layers, consistent with some embodiments. For example, the kernel 2320 provides memory management, processor management (e.g., scheduling), component management, networking, and security settings, among other functionality. The services 2322 can provide other common services for the other software layers. The drivers 2324 are responsible for controlling or interfacing with the underlying hardware, according to some embodiments. For instance, the drivers 2324 can include display drivers, signal processing drivers to optimize modeling computation, memory drivers, serial communication drivers (e.g., Universal Serial Bus (USB) drivers), WI-FI® drivers, audio drivers, power management drivers, camera drivers, and so forth.

In some embodiments, the libraries 2306 provide a low-level common infrastructure utilized by the applications 2310. The libraries 2306 can include system libraries 2330 such as libraries that can provide functions such as memory allocation functions, string manipulation functions, mathematic functions, and the like. In addition, the libraries 2306 can include API libraries 2332 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., UIWebView and WKWebView to provide web browsing functionality, Safari View Controller, WebView, Chrome Custom Tabs), and the like. The libraries 2306 may also include other libraries 2334.

The software frameworks 2308 provide a high-level common infrastructure that can be utilized by the applications 2310, according to some embodiments. For example, the software frameworks 2308 provide various graphic user interface (GUI) functions, high-level resource management, high-level location services, and so forth. The software frameworks 2308 can provide a broad spectrum of other APIs that can be utilized by the applications 2310, some of which may be specific to a particular operating system 2304 or platform. In various embodiments, the systems, methods, devices, and instructions described herein may use various files, macros, libraries, and other elements described herein.

Certain embodiments are described herein as including logic or a number of components, modules, elements, or mechanisms. Such modules can constitute either software modules (e.g., code embodied on a machine-readable medium or in a transmission signal) or hardware modules. A “hardware module” is a tangible unit capable of performing certain operations and can be configured or arranged in a certain physical manner. In various example embodiments, one or more computer systems (e.g., a standalone computer system, a client computer system, or a server computer system) or one or more hardware modules of a computer system (e.g., a processor or a group of processors) is configured by software (e.g., an application or application portion) as a hardware module that operates to perform certain operations as described herein.

In some embodiments, a hardware module is implemented mechanically, electronically, or any suitable combination thereof. For example, a hardware module can include dedicated circuitry or logic that is permanently configured to perform certain operations. For example, a hardware module can be a special-purpose processor, such as a field-programmable gate array (FPGA) or an application specific integrated circuit (ASIC). A hardware module may also include programmable logic or circuitry that is temporarily configured by software to perform certain operations. For example, a hardware module can include software encompassed within a general-purpose processor or other programmable processor. It will be appreciated that the decision to implement a hardware module mechanically, in dedicated and permanently configured circuitry, or in temporarily configured circuitry (e.g., configured by software) can be driven by cost and time considerations.

Accordingly, the phrase “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software can accordingly configure a particular processor or processors, for example, to constitute a particular hardware module at one instance of time and to constitute a different hardware module at a different instance of time. Alternatively, the hardware module incorporates hardware such as image processing hardware.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module performs an operation and stores the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors may also operate to support performance of the relevant operations in a “cloud computing” environment or as a “software as a service” (SaaS) or as a “platform as a service” (PaaS). For example, at least some of the operations may be performed by a group of computers (as examples of machines 2400 including processors 2410), with these operations being accessible via a network (e.g., the Internet) and via one or more appropriate interfaces (e.g., an application program interface (API)). In certain embodiments, for example, a client device may relay or operate in communication with cloud computing systems, and may store media content such as images or videos generated by devices described herein in a cloud environment.

The performance of certain of the operations may be distributed among the processors, not only residing within a single machine 2400, but deployed across a number of machines 2400. In some example embodiments, the processors 2410 or processor-implemented modules are located in a single geographic location (e.g., within a home environment, an office environment, or a server farm). In other example embodiments, the processors or processor-implemented modules are distributed across a number of geographic locations.

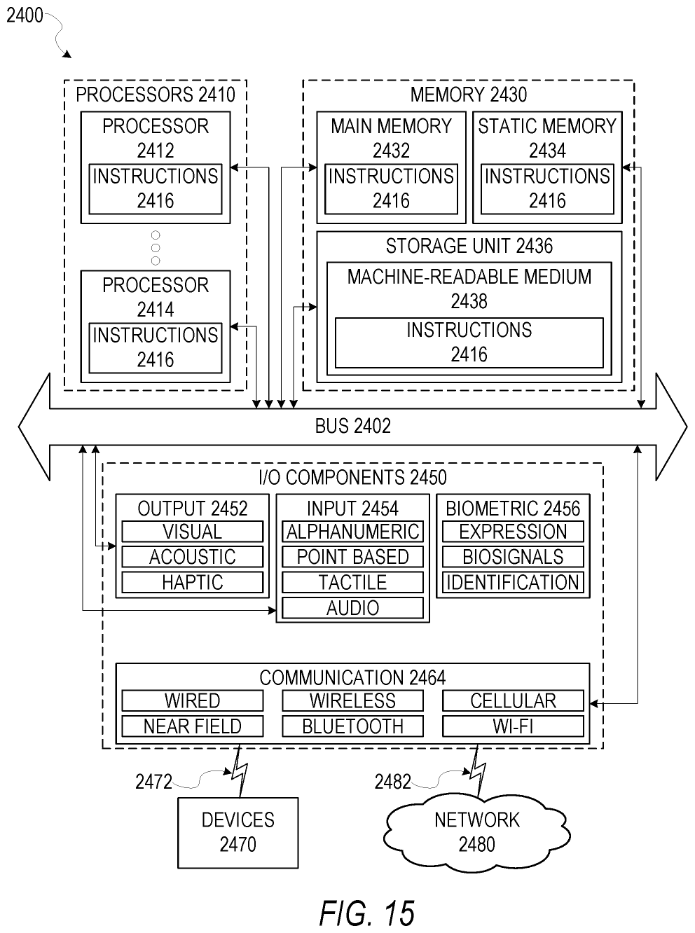

FIG. 15 is a diagrammatic representation of a machine 2400 in the form of a computer system within which a set of instructions are executable, causing the machine to perform generating and transmitting high definition video and photos according to some example embodiments discussed herein. FIG. 15 shows components of the machine 2400, which is, according to some embodiments, able to read instructions from a machine-readable medium (e.g., a machine-readable storage medium) and perform any one or more of the methodologies discussed herein. Specifically, FIG. 15 shows a diagrammatic representation of the machine 2400 in the example form of a computer system, within which instructions 2416 (e.g., software, a program, an application, an applet, an app, or other executable code) causing the machine 2400 to perform any one or more of the methodologies discussed herein are executable. In alternative embodiments, the machine 2400 operates as a standalone device or can be coupled (e.g., networked) to other machines. In a networked deployment, the machine 2400 operates in the capacity of a server machine or a client machine in a server-client network environment, or as a peer machine in a peer-to-peer (or distributed) network environment. Examples of the machine 2400 are a server computer, a client computer, a personal computer (PC), a tablet computer, a laptop computer, a netbook, a set-top box (STB), a personal digital assistant (PDA), a media system, a cellular telephone, a smart phone, a mobile device, or any machine capable of executing the instructions 2416, sequentially or otherwise, that specify actions to be taken by the machine 2400. Further, while only a single machine 2400 is illustrated, the term “machine” also includes a collection of machines 2400 that individually or jointly execute the instructions 2416 to perform any one or more of the methodologies discussed herein.

In various embodiments, the machine 2400 comprises processors 2410, memory 2430, and I/O components 2450, which are configurable to communicate with each other via a bus 2402. In an example embodiment, the processors 2410 (e.g., a central processing unit (CPU), a reduced instruction set computing (RISC) processor, a complex instruction set computing (CISC) processor, a graphics processing unit (GPU), a digital signal processor (DSP), an application specific integrated circuit (ASIC), a radio-frequency integrated circuit (RFIC), another processor, or any suitable combination thereof) include, for example, a processor 2412 and a processor 2424 that are able to execute the instructions 2416. In one embodiment the term “processor” includes multi-core processors 2410 that comprise two or more independent processors 2412, 2424 (also referred to as “cores”) that are able to execute instructions 2416 contemporaneously. Although FIG. 15 shows multiple processors 2410, in another embodiment the machine 2400 includes a single processor 2412 with a single core, a single processor 2412 with multiple cores (e.g., a multi-core processor 2412), multiple processors 2410 with a single core, multiple processors 2410 with multiples cores, or any combination thereof.

The memory 2430 comprises a main memory 2432, a static memory 2434, and a storage unit 2436 accessible to the processors 2410 via the bus 2402, according to some embodiments. The storage unit 2436 can include a machine-readable medium 2438 on which are stored the instructions 2416 embodying any one or more of the methodologies or functions described herein. The instructions 2416 can also reside, completely or at least partially, within the main memory 2432 such as DRAM or SDRAM or PSDRAM or PSRAM, within the static memory 2434, within at least one of the processors 2410 (e.g., within the processor's cache memory), or any suitable combination thereof, during execution thereof by the machine 2400. Accordingly, in various embodiments, the main memory 2432, the static memory 2434, and the processors 2410 are examples of machine-readable media 2438.

As used herein, the term “memory” refers to a machine-readable medium 2438 able to store data volatilely or non-volatilely and may be taken to include, but not be limited to, random-access memory (RAM), read-only memory (ROM), buffer memory, flash memory, and cache memory. While the machine-readable medium 2438 is shown, in an example embodiment, to be a single medium, the term “machine-readable medium” includes a single medium or multiple media (e.g., a centralized or distributed database, or associated caches and servers) storing the instructions 2416. The term “machine-readable medium” also includes any medium, or combination of multiple media, that is capable of storing instructions (e.g., instructions 2416) for execution by a machine (e.g., machine 2400), such that the instructions 2416, when executed by one or more processors of the machine 2400 (e.g., processors 2410), cause the machine 2400 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” includes, but is not limited to, one or more data repositories in the form of a solid-state memory (e.g., flash memory), an optical medium, a magnetic medium, other non-volatile memory (e.g., erasable programmable read-only memory (EPROM)), or any suitable combination thereof. The term “machine-readable medium” specifically excludes non-statutory signals per se.

The I/O components 2450 include a wide variety of components to receive input, provide output, produce output, transmit information, exchange information, capture measurements, and so on. In general, the I/O components 2450 can include many other components that are not shown in FIG. 15. The I/O components 2450 are grouped according to functionality merely for simplifying the following discussion, and the grouping is in no way limiting. In various example embodiments, the I/O components 2450 include output components 2452 and input components 2454. The output components 2452 include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 2454 include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

Communication is implementable using a wide variety of technologies. The I/O components 2450 may include communication components 2464 operable to couple the machine 2400 to a network 2480 or devices 2470 via a coupling 2482 and a coupling 2472, respectively. For example, the communication components 2464 include a network interface component or another suitable device to interface with the network 2480. In further examples, communication components 2464 include wired communication components, wireless communication components, cellular communication components, near field communication (NFC) components, BLUETOOTH® components (e.g., BLUETOOTH® Low Energy), WI-FI® components, and other communication components to provide communication via other modalities. The devices 2470 may be another machine or any of a wide variety of peripheral devices (e.g., a peripheral device coupled via a Universal Serial Bus (USB)).

### Transmission Medium

In various example embodiments, one or more portions of the network 2480 can be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the public switched telephone network (PSTN), a plain old telephone service (POTS) network, a cellular telephone network, a wireless network, a WI-FI® network, another type of network, or a combination of two or more such networks. For example, the network 2480 or a portion of the network 2480 may include a wireless or cellular network, and the coupling 2482 may be a Code Division Multiple Access (CDMA) connection, a Global System for Mobile communications (GSM) connection, or another type of cellular or wireless coupling. In this example, the coupling 2482 can implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-speed Packet Access (HSPA), Worldwide Interoperability for Microwave Access (WiMAX), Long Term Evolution (LTE) standard, HSDPA (High Speed Downlink Packet Access), HSUPA (High Speed Uplink Packet Access), others defined by various standard-setting organizations, other long range protocols, or other data transfer technology.

Furthermore, the machine-readable medium 2438 is non-transitory (in other words, not having any transitory signals) in that it does not embody a propagating signal. However, labeling the machine-readable medium 2438 “non-transitory” should not be construed to mean that the medium 2438 is incapable of movement; the medium 2438 should be considered as being transportable from one physical location to another. Additionally, since the machine-readable medium 2438 is tangible, the medium 2438 is a machine-readable device.

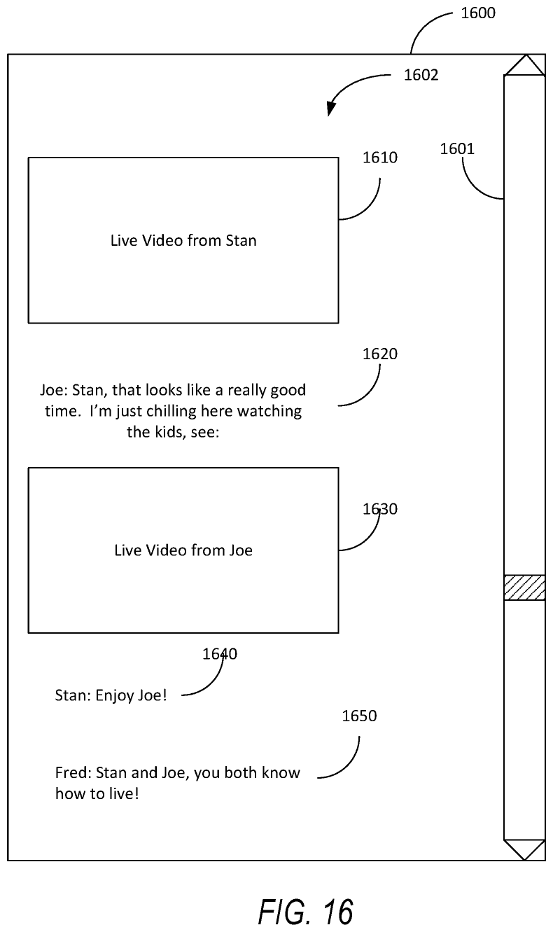

FIG. 16 is a mock-up of an exemplary instant messaging conversation window 1600 that may be presented on a screen of the handset 102. The conversation window 1600 shows at least three participants, Joe, Stan, and Fred to the conversation 1602 within the conversation window 1600. Instant messages from any of the participants appear vertically in chronological order of the sending of the instant messages. Therefore, older instant messages appear above more recent instant messages. The conversation window 1600 includes a scroll bar 1601, enabling a user to scroll within the list of chronologically ordered instant messages. The instant messages may include at least video messages and/or text messages. Video messages may include recorded video and/or live video.

The conversation 1602 includes a live video instant message 1610 from Stan. The live video instant message 1610 may be configured to receive a live stream from Stan's device until Stan disables the live stream or connectivity with Stan's handset 102 is otherwise lost. The live video 1610 may appear on each handset 102 of participants in the conversation 1602. The conversation 1602 also includes text messages, including text message 1620 from Joe. The text messages may also appear on each mobile device of the participants in the conversation 1602.

The conversation 1602 also includes a live video instant message 1630 from Joe. The live video instant message 1610 from a first user (Stan) and live video instant message 1630 from a second user (Joe) may stream simultaneously within the conversation 1602. The conversation 1602 also includes a text instant message from Stan 1640, appearing below the live video instant message from Joe 1630. The text instant message 1640 may have been send after the live video instant message 1630 from Joe was initiated, thus, the text instant message 1640 appears below the live video instant message 1630 from Joe in the conversation 1602.

The conversation 1602 also includes a text instant message 1650 from Fred. The text instant message 1650 may have been sent after the live video instant message 1630 from Joe was initiated, and after the text instant message 1640, thus it appears below each of the instant messages 1630 and 1640.

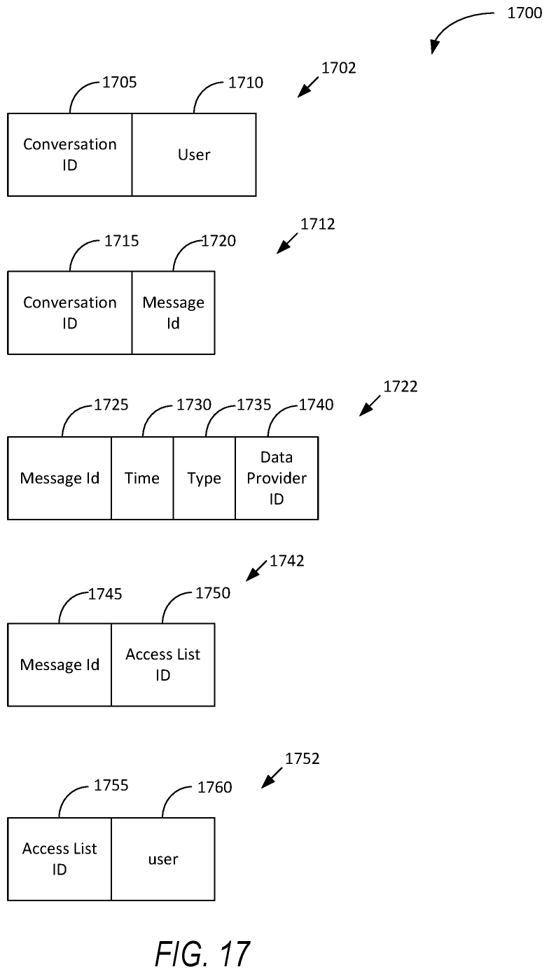

FIG. 17 is an exemplary database to facilitate the conversation 1602 discussed above with respect to FIG. 16. The database 1700 includes a participant table 1702. The participant table 1702 includes a conversation identifier 1705 and a user identifier 1710. The user identifier 1710 identifies a participant in the conversation identified via the conversation identifier 1705. Conversations having multiple participants may have multiple rows in the participant table 1702.

The database 1700 also includes a conversation table 1712. The conversation table 1712 includes a conversation identifier 1715 and message identifier 1720. The conversation table 1712 stores messages that are within each conversation. A conversation including multiple messages, such as conversation 1602 discussed above, may have multiple rows in the conversation table 1712, one row for each message.

Database 1700 also includes a message table 1722. The message table 1722 includes a message identifier 1725, a message time 1730, a message type 1735, and a data provider identifier 1740. The data provider id may enable the disclosed methods and systems to obtain data for the message. For example, the data provider id may identify a text message, a video file, or a live video stream identifier.

The database 1700 also includes a message access table 1742. The disclosed methods and systems may provide each message to have its own access list. Thus, a user streaming a live video could enable some participants in the conversation to see the live video, while other participants are unable to access the live video. To facilitate this capability, the message access table 1742 includes a message identifier 1745 and an access list identifier 1750. The access list identifier 1750 identifies an access list for the message identifier via the message identifier 1745.

The database 1700 also includes an access list table 1752. The access list table 1752 includes an access list identifier 1755 and user field 1760. The user 1760 identifier a user granted access by the access list identified via the access list id. Thus, an access list may provide access to multiple users via multiple rows in the access list table 1752. Multiple users may have access to a message identified via message id 1745 by identifying such an access list via the access list id column 1750.

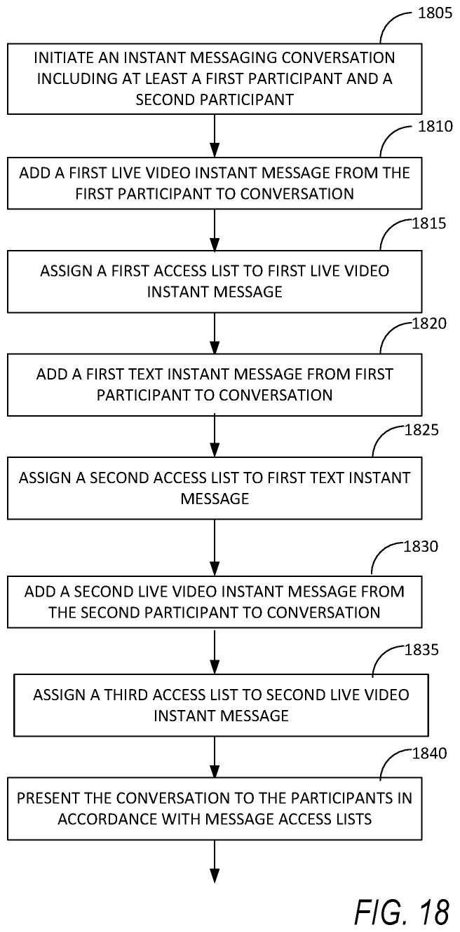

FIG. 18 is a flowchart for a method of providing access to messages in an instant message conversation. One or more of the functions discussed below with respect to FIG. 18 may be performed by a hardware processor. For example, in some aspects, instructions 2414 may configure the processor(s) 2414 to perform one or more of the functions discussed below. Process 1800 enables each sender of a message of an instant message conversation to control access to the message. Thus, while there may be “n” participants in an instant message conversation, >n participants may have access to a particular message, as identified by the sender of the message.

Additionally, process 1800 enables multiple participants to stream live video within the conversation simultaneously. Thus, at least two live videos may be simultaneously played within the conversation. In these aspects, as the conversation continues, a first live video may scroll, in some cases along with other instant messages, out of the conversation window 1600. However, a reader of the conversation may be able to scroll, for example using the scroll bar 1601, back to the first live video instant message at any time.

In block 1805, an instant messaging conversation is initiated, including at least a first participant and a second participant. Block 1805 may include establishing two entries in the participant table 1702, a first entry having a conversation identifier and the second a user identifier for the first participant. The second entry may have the same conversation identifier but a user identifier for the second participant. Both participants may be users in a social networking system. The social networking system may maintain a separate database that maintains user identifiers, authentication credentials, profile information, and the like for each user of the social network.

In block 1810, a first live video instant message is added to the conversation. The first live video may be added by the first participant. In other words, a first video feed from the first participant's handset 102 may provide video for the first live video. Block 1810 may include generating a row in the conversation table 1712. The row may identify the conversation initiated in block 1805 via the conversation id 1715, and may generate a message identifier for the first live video instant message and store this in the message id column 1720.

Block 1810 may also include adding an entry to the message table 1722 storing the message id in the message id field 1725, a time the first live video instant message was added to the conversation in time field 1730, a type of the message, for example, the type may indicate the message is a live video, and a data provider id 1740. In some aspects, the data provider id field may identify streaming parameters for the first live video. In some aspect, the streaming parameters may identify a stream available from a server. Thus, the streaming parameters may include a hostname or IP address of the server (which may be a virtual server), and connection parameters such as a service access point, protocol type, and the like.

Block 1815 assigns a first access list to the first live video instant message. In some aspects, the access list for the first live video may be specified by the first participants handset 102. The access list may specify a list of users within the conversation that may access the live video. A number of users in the list of users may be equal to or less than the number of participants of the conversation.

Assigning the access list in block 1815 may include adding a row to the message access table 1742. The row identifies the first live video instant message via the message id column 1745, and the assigned access list via the access list identifier column 1750. Assigning the access list may also include generating the access list if a new access list is specified for the first live video instant message. Generating the access list may include adding one or more rows to the access list table 1752, each row identifying the same access list via access list id column 1755 and a user (conversation participant) included in the access list via the user column 1760.

In block 1820, a first text instant message from the first participant is added to the conversation. Adding the first text instant message may include Block 1820 may include generating a row in the conversation table 1712. The row may identify the conversation initiated in block 1805 via the conversation id 1715, and may generate a message identifier for the first text instant message and store this in the message id column 1720.

Block 1820 may also include adding an entry to the message table 1722 storing the message id in the message id field 1725, a time the first text instant message was added to the conversation in time field 1730, a type of the message, for example, the type may indicate the message is a text message, and a data provider id 1740. In some aspects, the data provider id field for a text message may include the text message itself. In other aspects, the column 1740 may identify parameters for a network service (Rest/SOAP) for obtaining the text message.

In block 1825, a second access list is added to the first text instant message. In some aspects, the second access list for the first text instant message may be specified by the first participant's handset 102. The second access list may specify a list of users within the conversation that may access the first text instant message. A number of users in the list of users may be equal to or less than the number of participants of the conversation.

Assigning the second access list in block 1825 may include adding a row to the message access table 1742. The row identifies the first text instant message via the message id column 1745, and the assigned second access list via the access list identifier column 1750. Assigning the second access list may also include generating the second access list if a new access list is specified for the first text instant message. Generating the second access list may include adding one or more rows to the access list table 1752, each row identifying the same second access list via access list id column 1755 and a different user (conversation participant) included in the access list via the user column 1760.

In block 1830, a second live video instant message is added to the conversation. The second live video instant message may be added by the second participant. In other words, a second video feed from the second participant's handset 102 may provide video for the second live video. Block 1810 may include generating a row in the conversation table 1712. The row may identify the conversation initiated in block 1805 via the conversation id 1715, and may generate a message identifier for the second live video instant message and store this in the message id column 1720.

Block 1830 may also include adding an entry to the message table 1722 storing the message id in the message id field 1725, a time the second live video instant message was added to the conversation in time field 1730, a type of the message, for example, the type may indicate the message is a live video, and a data provider id 1740. In some aspects, the data provider id field may identify streaming parameters for the second live video. In some aspect, the streaming parameters may identify a stream available from a server. Thus, the streaming parameters may include a second hostname or second IP address of the server (which may be a virtual server), and connection parameters such as a service access point, protocol type, and the like.

Block 1835 assigns a third access list to the second live video instant message. In some aspects, the third access list for the second live video may be specified by the second participant's handset 102. The third access list may specify a third list of users within the conversation that may access the second live video instant message. A number of users in the third list of users may be equal to or less than the number of participants of the conversation.

Assigning the third access list in block 1835 may include adding a row to the message access table 1742. The row identifies the second live video instant message via the message id column 1745, and the assigned third access list via the access list identifier column 1750. Assigning the third access list may also include generating the third access list if a new access list is specified for the second live video instant message by the (e.g.) second participant's handset. Generating the third access list may include adding one or more rows to the access list table 1752, each row identifying the same third access list via access list id column 1755 and a user (conversation participant) included in the third access list via the user column 1760.

In block 1840, the conversation is presented in accordance with the message access lists. In some aspects, block 1840 includes presenting at least two live videos within the conversation simultaneously.

In some aspects, process 1800 may be performed by one or more server machines in communication with at least handsets of the first and second participants. In these aspects, presenting the conversation may include transmitting data relating to the conversation to each of the participant handsets based on the access lists. In the case of simultaneously live videos, simultaneous streams for the first and second live video instant messages may be transmitted to one or more participant's handsets. If an access list for a message indicates a particular user/participants has access to the message, the message is transmitted to the user's/participant's handset. If the access list for the message indicates a particular user/participant does not have access to the message, the message is not transmitted to the user's participant's handset.

Some other aspects may enforce access lists at the handset itself. In these aspects, messages of the conversation may be transmitted from the instant messaging server(s) to the handsets of the participants, and the handsets may not display messages for which access is not indicated for the user logged into the handset.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The description above includes systems, methods, techniques, instruction sequences, and computing machine program products that embody illustrative embodiments of the disclosure. In the description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

I claim:

1. A method of displaying information, comprising:
presenting, by a client device, a scrollable first plurality of thumbnails on a display screen of the client device, each of the first plurality of thumbnails representing different content from a first source of information;
presenting, by the client device, a scrollable second plurality of thumbnails on the display screen, the second plurality of thumbnails positioned laterally adjacent to the first plurality of thumbnails, each of the second plurality of thumbnails representing different content from a second source of information;
receiving, by the client device, content from the second source of information; and
updating, by the client device, the presentation of the first plurality of thumbnails and the second plurality of thumbnails by changing an ordinal position of the first plurality of thumbnails relative to the second plurality of thumbnails in response to the received content.

2. The method of claim 1, further comprising:
receiving, by the client device, input indicating a selection of one of the first scrollable plurality of thumbnails;
requesting, in response to the input, content corresponding to the one scrollable thumbnail from the first source of information based on the representation of the first source of information by the first plurality of scrollable thumbnails.

3. The method of claim 1, further comprising:
receiving, by the client device, a message from a network indicating at least one of the first plurality of thumbnails, and an association between the one thumbnail and the first source of information; and
presenting the one thumbnail in response to receiving the message.

4. The method of claim 1, further comprising:
receiving, by the client device, input indicating a scroll operation for the first plurality of scrollable thumbnails;
scrolling the first plurality of thumbnails in response to the input while maintaining a position of the second plurality of thumbnails.

5. The method of claim 4, wherein the input indicating a scroll operation is a horizontal swipe, and the scrolling of the first plurality of thumbnails is a horizontal scroll.

6. The method of claim 1, wherein the first plurality of thumbnails are presented in a horizontal row, and the second plurality of thumbnails are presented in a second horizontal row.

7. The method of claim 6, wherein updating the ordinal position comprises moving the second plurality of thumbnails above the first plurality of thumbnails.

8. The method of claim 4, wherein the input indicating a scroll operation is a vertical swipe, and the scrolling of the first plurality of thumbnails is a vertical scroll.

9. The method of claim 1, wherein the first plurality of thumbnails are presented in a vertical column, the second plurality of thumbnails are presented in a second vertical column, and the first and second vertical columns are laterally adjacent.

10. The method of claim 8, wherein updating the ordinal position comprises moving the second plurality of thumbnails to the left of the first plurality of thumbnails.

11. A wireless handset, comprising:
an electronic hardware processor;
electronic memory storing instructions that when executed, configure the electronic hardware processor to:
present a scrollable first plurality of thumbnails, each of the first plurality of thumbnails representing different content from a first source of information;
present a scrollable second plurality of thumbnails, positioned laterally adjacent to the first plurality of thumbnails, each of the second plurality of thumbnails representing different content from a second source of information'
receive content from the second source of information; and
update the presentation of the first plurality of thumbnails and the second plurality of thumbnails by changing an ordinal position of the first plurality of thumbnails relative to the second plurality of thumbnails in response to the received content.

12. The wireless handset of claim 11, wherein the electronic memory stores further instructions that when executed, configure the electronic hardware processor to:
receive input indicating a selection of one of the first scrollable plurality of thumbnails;
request content corresponding to the one scrollable thumbnail from the first source of information based on the representation of the first source of information by the first plurality of scrollable thumbnails.

13. The wireless handset of claim 11, wherein the electronic memory stores further instructions that when executed, configure the electronic hardware processor to:
receive a message from a network indicating at least one of the first plurality of thumbnails, and an association between the one thumbnail and the first source of information; and
present the one thumbnail in response to receiving the message.

14. The wireless handset of claim 11, wherein the electronic memory stores further instructions that when executed, configure the electronic hardware processor to:
receiving, by the client device, input indicating a scroll operation for the first plurality of scrollable thumbnails;
scrolling the first plurality of thumbnails in response to the input while maintaining a position of the second plurality of thumbnails.

15. The wireless handset of claim 14, wherein the input indicating a scroll operation is a horizontal swipe, and the scrolling of the first plurality of thumbnails is a horizontal scroll.

16. The wireless handset of claim 14, wherein the input indicating a scroll operation is a vertical swipe, and the scrolling of the first plurality of thumbnails is a vertical scroll.

17. The wireless handset of claim 14, wherein the first plurality of thumbnails are presented in a vertical column, the second plurality of thumbnails are presented in a second vertical column, and the first and second vertical columns are laterally adjacent.

18. A non-transitory computer readable medium comprising instructions that when executed cause a processor to perform a method of displaying content, comprising:
presenting, by a client device, a scrollable first plurality of thumbnails on a display screen of the client device, each of the first plurality of thumbnails representing different content from a first source of information;
presenting, by the client device, a scrollable second plurality of thumbnails on the display screen, the second plurality of thumbnails positioned laterally adjacent to the first plurality of thumbnails, each of the second plurality of thumbnails representing different content from a second source of information;
receiving, by the client device, content from the second source of information; and
updating, by the client device, the presentation of the first plurality of thumbnails and the second plurality of thumbnails by changing an ordinal position of the first plurality of thumbnails relative to the second plurality of thumbnails in response to the received content.
